(19) United States
(12) Patent Application Publication
(10) Pub. No.: US 2011/0245033 A1
(43) Pub. Date: Oct. 6, 2011

(54) VEHICULAR HYBRID DRIVE SYSTEM

(75) Inventors: Akihiro SATO, Nagoya-shi (JP); Yasuyuki KATO, Miyoshi-shi (JP); Akiko NISHIMINE, Toyota-shi (JP); Masami KANNO, Toyota-shi (JP)

(73) Assignee: TOYOTA JIDOSHA KABUSHIKI KAISHA, Toyota-shi (JP)

(21) Appl. No.: 13/048,442

(22) Filed: Mar. 15, 2011

(30) Foreign Application Priority Data
Apr. 2, 2010 (JP) 2010-086563

(51) Int. Cl. B60W 20/00; B60W 10/08; B60W 10/06

(52) U.S. Cl. 477/3; 180/65.265; 903/930

(57) ABSTRACT

In a vehicular hybrid drive system including an engine, a first rotary machine that is mechanically connected to the engine and is used at least as a generator, a belt-and-pulley continuously variable transmission to which output of the engine and the first rotary machine is transmitted via an input shaft, and a clutch device that permits and interrupts power transmission between the belt-and-pulley continuously variable transmission and driving wheels, and a second rotary machine that is used at least as an electric motor, and is arranged to cause a vehicle to run even when the engine is stopped, an input pulley of the belt-and-pulley continuously variable transmission is disposed coaxially with the engine, and is mechanically connected to the engine via the input shaft, such that the input pulley is rotated and stopped along with the engine at all times.

### INCORPORATION BY REFERENCE

The disclosure of Japanese Patent Application No. 2010-086563 filed on Apr. 2, 2010, including the specification, drawings and abstract is incorporated herein by reference in its entirety.

### BACKGROUND OF THE INVENTION

1. Field of the Invention

The invention relates to a vehicular hybrid drive system. In particular, the invention relates to a vehicular hybrid drive system that permits a flywheel to be reduced in size or eliminated, and can be thus constructed with reduced weight.

2. Description of Related Art

A vehicular hybrid drive system is known which includes (a) an engine, (b) a first rotary machine that is mechanically connected to the engine and is used at least as a generator, (c) a belt-and-pulley continuously variable transmission to which the output of the engine and the first rotary machine is transmitted via an input shaft, (d) a clutch device that permits and interrupts power transmission between the belt-and-pulley continuously variable transmission and driving wheels, and (e) a second rotary machine that is used at least as an electric motor, and is arranged to cause the vehicle to run even when the engine is stopped. In one example of the vehicular hybrid drive system as described in Japanese Patent Application Publication No. 2005-59787 (JP-A-2005-59787), motor-generators are used as the first rotary machine and second rotary machine, and the engine is provided with a flywheel for reducing fluctuations in the torque and rotation (rotational speed) of the engine, while a forward/reverse drive switching device having a hydraulic clutch, or the like, is disposed between the engine and the belt-and-pulley continuously variable transmission.

In the meantime, the inertia, for example, of the flywheel needs to be set so that the fluctuations in connection with the engine are held within a specified range even when the forward/reverse drive switching device is released for a moment and the power transmission is interrupted. Thus, the provision of the flywheel results in an increase of the weight and deterioration of the fuel efficiency.

### SUMMARY OF THE INVENTION

The invention provides a vehicular hybrid drive system that permits a flywheel to be reduced in size or eliminated, and can be thus constructed with reduced weight.

One aspect of the invention is concerned with a vehicular hybrid drive system including (a) an engine, (b) a first rotary machine that is mechanically connected to the engine and is used at least as a generator, (c) a belt-and-pulley continuously variable transmission to which output of the engine and the first rotary machine is transmitted via an input shaft, (d) a clutch device that permits and interrupts power transmission between the belt-and-pulley continuously variable transmission and driving wheels, and (e) a second rotary machine that is used at least as an electric motor, and is arranged to cause a vehicle to run even when the engine is stopped. In the drive system, an input pulley of the belt-and-pulley continuously variable transmission is disposed coaxially with the engine, and is mechanically connected to the engine via the input shaft, such that the input pulley is rotated and stopped along with the engine at all times.

In the vehicular hybrid drive system as described above, the input pulley of the belt-and-pulley continuously variable transmission is mechanically connected to the engine via the input shaft, and is adapted to be rotated and stopped along with the engine at all times; therefore, substantially the same function as that of a flywheel is provided by the inertia of the input pulley. This makes it possible to eliminate the flywheel for reducing fluctuations in the torque and rotation (rotational speed) of the engine, or reduce the size of the flywheel, which leads to weight reduction, improved fuel efficiency, and reduction in the cost of production of the system. Further, fluctuations in the torque and rotation of the first rotary machine mechanically connected to the engine are also reduced by the inertia of the input pulley; therefore, the NV (noise, vibration) performance is improved.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram showing the construction of a vehicular hybrid drive system according to one embodiment of the invention, along with a control system associated with shift control and control of switching a driving power source;

FIG. 2 is a view showing one example of driving power source map used in driving power source switching control for switching between engine running and motor running;

FIGS. 3A and 3B are views useful for explaining a plurality of running modes implemented by the vehicular hybrid drive system of FIG. 1; and

FIG. 4 is a schematic diagram showing the construction of a vehicular hybrid drive system according to another embodiment of the invention.

### DETAILED DESCRIPTION OF EMBODIMENTS

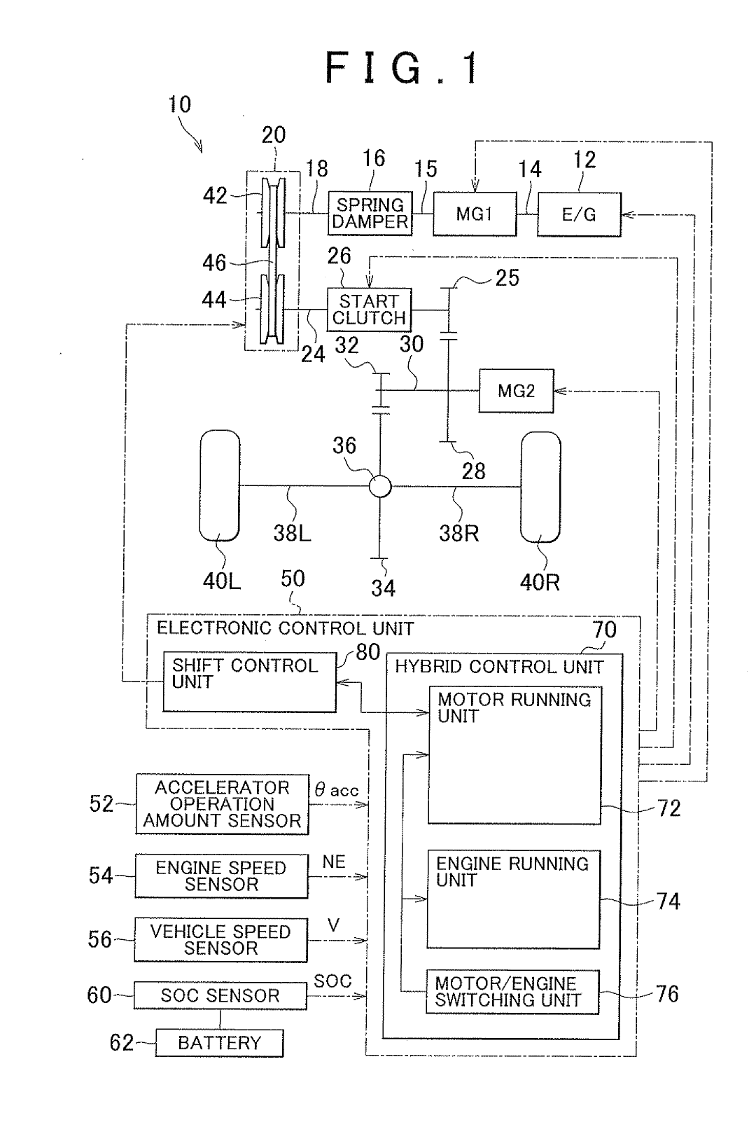

Some embodiments of the invention will be described in detail with reference to the drawings. FIG. 1 is a schematic diagram of a vehicular hybrid drive system 10 as one embodiment of the invention. The vehicular hybrid drive system 10 includes an engine 12, a first motor-generator MG1 connected to a crankshaft 14 of the engine 12, a spring damper 16 connected to the first motor-generator MG1 via an intermediate shaft 15, a transmission 20 connected to the first motor-generator MG1 via an input shaft 18, and a start clutch 26 provided between an output shaft 24 of the transmission 20 and a first gear 25 for connecting and disconnecting the output shaft 24 and the first gear 25 so as to permit and inhibit power transmission therebetween. The vehicular hybrid drive system 10 further includes a countershaft 30 on which a second gear 28 that meshes with the first gear 25 is mounted, a second motor-generator MG2 connected to the countershaft 30, a third gear 32 mounted on the countershaft 30, a differential gear unit 36 provided with a fourth gear 34 that meshes with the third gear 32, and left and right, front driving wheels 40L, 40R connected to the differential gear unit 36 via left and right axles 38L, 38R, respectively. The engine 12 is in the form of an internal combustion engine in which fuel is burned so as to generate power, and each of the first motor-generator MG1 and the second motor-generator MG2 may be used as an electric motor and a generator. The first motor-generator MG1 may be regarded as a first rotary machine, and the second motor-generator MG2 may be regarded as a second rotary machine.

In this embodiment, a belt-and-pulley continuously variable transmission is used as the transmission 20. The transmission 20 includes an input pulley 42 that is disposed coaxially with the input shaft 18 and is coupled to the input shaft 18 via splines, or the like, such that the input pulley 42 cannot rotate relative to the input shaft 18, an output pulley 44 that is disposed coaxially with the output shaft 24 and is coupled to the output shaft 24 via splines, or the like, such that the output pulley 44 cannot rotate relative to the output shaft 24, and an annular transmission belt 46 that engages with the input pulley 42 and the output pulley 44 to extend around the pulleys 42, 44. Each of the input pulley 42 and the output pulley 44 is a variable pulley whose V-groove width, or radius at which the belt engages the pulley, can be changed. In operation, the speed ratio γ (=the rotational speed of the input shaft 18/the rotational speed of the output shaft 24) can be continuously changed by changing the V-groove width by means of a hydraulic cylinder, or the like. The engine 12, first motor-generator MG1, spring damper 16, and the input pulley 42 are disposed on the same axis, and adjacent ones of these members are mechanically coupled to each other via splines, or the like, such that they cannot rotate relative to each other. With this arrangement, the input pulley 42 is rotated and stopped along with the engine 12 and the first motor-generator MG1 at all times, in a condition where the spring damper 16 allows the input pulley 42 to rotate slightly relative to the engine 12 and the first motor-generator MG1. The spring damper 16 is a damper device that absorbs fluctuations in the rotation of the engine 12 and the first motor-generator MG1 by means of a spring(s), or the like. The output pulley 44 is disposed coaxially with the start clutch 26 and the first gear 25. The start clutch 26 is a hydraulic friction device, and may be regarded as a clutch device that connects and disconnects the output shaft 24 and the first gear 25 so as to permit and inhibit power transmission therebetween. Namely, power is transmitted between the output shaft 24 and the first gear 25 when the start clutch 26 is engaged, and power is inhibited from being transmitted between the output shaft 24 and the first gear 25 (i.e., the output shaft 24 and the first gear 25 are disconnected from each other) when the start clutch 26 is released.

The vehicular hybrid drive system 10 constructed as described above includes an electronic control unit 50 that performs hybrid control for switching the driving power source and shift control of the belt-and-pulley continuously variable transmission 20. The electronic control unit 50 includes a microcomputer, and is configured to perform signal processing according to programs stored in advance in ROM, utilizing the temporary storage function of RAM. The electronic control unit 50 receives signals indicative of the accelerator operation amount θacc as the amount of operation of the accelerator pedal, the rotational speed NE of the engine 12 (engine speed), the vehicle speed V, and the SOC (state of charge) of a battery 62 as a power supply of the first motor-generator MG1 and the second motor-generator MG2, from an accelerator operation amount sensor 52, an engine speed sensor 54, a vehicle speed sensor 56, and an SOC sensor 60, respectively. In addition to these signals, various types of information required for various controls are supplied from sensors, and the like, to the electronic control unit 50. The above-mentioned SOC is obtained by sequentially calculating the amount of electricity charged into the battery 62 and the amount of electricity discharged from the battery 62, for example.

The electronic control unit 50 basically includes a hybrid control unit 70 and a shift control unit 80 as functional units. The hybrid control unit 70 controls running of the vehicle by selecting one running mode from two or more running modes during forward running and backward running, as shown in FIGS. 3A, 3B. The hybrid control unit 70 includes a motor running unit 72, an engine running unit 74, and a motor/engine switching unit 76. The motor running unit 72 is involved in motor-based running in which the vehicle runs using only the second motor-generator MG2 as the driving power source, and has two running modes, i.e., an EV (Electric Vehicle) running mode and a series HEV running mode, to be implemented during forward running and backward running, respectively. In the EV running mode implemented during forward running, the engine 12 is stopped while the start clutch 26 is in a released state, and the second motor-generator MG2 is controlled to be driven with power supplied thereto, i.e., the second motor-generator MG2 operates as an electric motor, so as to run the vehicle forward. In the series HEV running mode implemented during forward running, the engine 12 is operated during running in the EV mode so as to rotate or drive the first motor-generator MG1, and the first motor-generator MG1 is controlled to generate electric power or energy, i.e., the first motor-generator MG1 operates as a generator, so that the obtained electric energy is supplied to the second motor-generator MG2. In the EV running mode implemented during backward running, the engine 12 is stopped while the start clutch 26 is in a released state, and the second motor-generator MG2 is controlled to be driven or rotated in the reverse direction so as to run the vehicle backward, i.e., the second motor-generator MG2 operates as an electric motor for running the vehicle backward. In the series HEV running mode implemented during backward running, the engine 12 is operated during running in the EV mode so as to rotate or drive the first motor-generator MG1, and the first motor-generator MG1 is controlled to generate electric power or energy, i.e., the first motor-generator MG1 operates as a generator, so that the obtained electric energy is supplied to the second motor-generator MG2. If the SOC of the battery 62 becomes smaller than a predetermined value during forward running or backward running, the running mode is switched from the EV running mode to the series HEV running mode. The predetermined value of the SOC is set to, for example, the lower limit of an SOC range over which the engine 12 can be cranked and started by the first motor-generator MG1.

The engine running unit 74 is involved in engine-based running in which the vehicle runs using the engine 12 as the driving power source. The engine running unit 74 has three running modes, i.e., engine running mode, parallel HEV running mode, and series parallel HEV running mode, to be implemented only during forward running of the vehicle. In any of these running modes, the start clutch 26 is engaged. In the engine running mode, the engine 12 is operated so as to run the vehicle forward, and the first motor-generator MG1 and the second motor-generator MG2 are both freely rotated to produce zero torque. In the parallel HEV running mode, the engine 12 is operated and the first motor-generator MG1 is controlled to operate as an electric motor, so as to run the vehicle forward, while the second motor-generator MG2 is freely rotated to produce zero torque. It is, however, to be understood that the second motor-generator MG2, in place of the first motor-generator MG1, may be controlled to operate as an electric motor, and that the first motor-generator MG1 and second motor-generator MG2 may be both controlled to operate as electric motors. In the series parallel HEV running mode, the engine 12 is operated and the second motor-generator MG2 is controlled to operate as an electric motor, so as to run the vehicle forward, while the first motor-generator MG1 is controlled to generate electric power or energy, so that the obtained electric energy is supplied to the second motor-generator MG2. In the parallel HEV running mode and series parallel HEV running mode, greater driving force can be generated as compared with that generated in the engine running mode; therefore, the parallel HEV running mode or the series parallel HEV running mode is implemented when a request for acceleration is made with the accelerator operation amount θacc being rapidly increased, or when the vehicle is running at a high speed, for example. The parallel HEV running mode is selected when the SOC of the battery 62 is relatively large, and the series parallel HEV running mode is selected when the SOC is relatively small. It is also possible to provide other running modes, such as a charge running mode in which the first motor-generator MG1 is controlled to generate electric power while the second motor-generator MG2 is not used as an electric motor, and the vehicle runs using the engine 12 as a driving power source while charging the battery 62 at the same time.

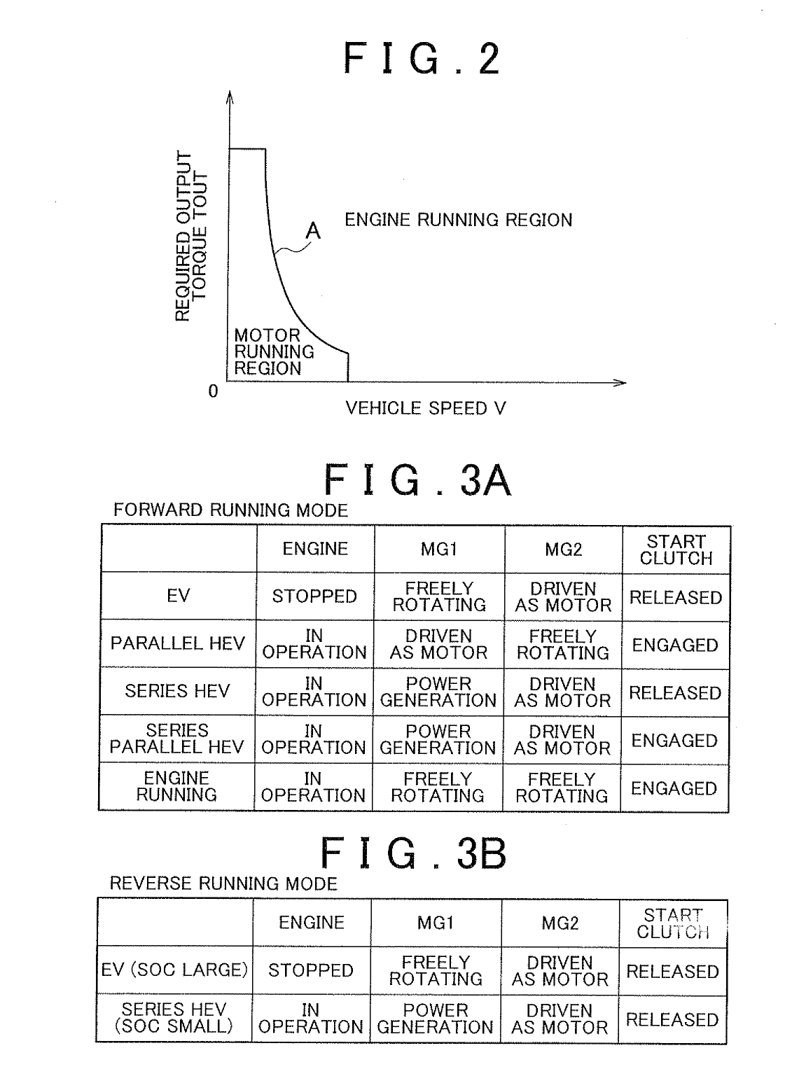

The motor/engine switching unit 76 switches the vehicle between motor-based running under control of the motor running unit 72 and engine-based running under control of the engine running unit 74, according to a driving power source map as shown in FIG. 2, for example. In FIG. 2, the required output torque TOUT is obtained based on the accelerator operation amount θacc, for example. In the driving power source map of FIG. 2, a motor running region is defined by the solid line A, to be located on the lower-vehicle-speed, lower-required-output-torque side of the solid line A, and a selected running mode is implemented by the motor running unit 72 in the motor running region. Also, an engine running region is defined by the solid line A, to be located on the higher-vehicle-speed, higher-required-output-torque side of the solid line A, and a selected running mode is implemented by the engine running unit 74 in the engine running region.

The shift control unit 80 performs shift control of the belt-and-pulley continuous variable transmission 20 during engine-based running, namely, when the vehicle runs using the engine 12 as the driving power source. The shift control unit 80 determines a target input rotational speed (corresponding to the speed ratio γ) according to a predetermined shift map, using the required driving force, such as the throttle opening θacc, and the vehicle speed V as parameters, and performs shift control so that the rotational speed of the input pulley 42, or the engine speed NE, becomes equal to the target input rotational speed. When the series HEV running mode is implemented by the motor running unit 72 during forward running, the shift control unit 80 also performs synchronization control for controlling the speed ratio γ of the belt-and-pulley continuous variable transmission 20 according to the engine speed NE and the vehicle speed V, so that upstream and downstream elements, i.e., the output shaft 24 and the first gear 25, of the start clutch 26 that is in a released state rotate in synchronism with each other. Namely, the speed ratio γ of the belt-and-pulley continuously variable transmission 20 is controlled according to the engine speed NE, so that the rotational speed of an input-side rotating element (on the output shaft 24 side) of the start clutch 26 becomes substantially equal to that of an output-side rotating element (on the first gear 25 side) which is determined according to the vehicle speed V. In this case, shift control may be performed so that the rotational speed of the output pulley 44 becomes equal to a given target rotational speed that is determined according to the vehicle speed V. With this arrangement, when the motor/engine switching unit 76 switches the vehicle from motor-based running to engine-based running in response to an operation to increase the amount of depression of the accelerator pedal or an increase of the vehicle speed V, for example, the start clutch 26 can be quickly engaged without causing shock to occur, and the driving force can be quickly obtained from the engine 12 due to reduction of torque used for power generation control of the first motor-generator MG1. Since the engine 12 operates in the series HEV running mode only to rotate or drive the first motor generator MG1 to generate electric power, the engine speed NE during running in this mode is set in advance to a predetermined fixed value in view of the fuel efficiency and the power generation efficiency of the first motor-generator MG1, for example, and the above-described synchronization control is carried out when the vehicle speed is equal to or larger than a specified speed, for prevention of engine stalling. However, the engine speed NE may be changed according to the amount of operation of the accelerator pedal θacc by the driver, or the like.

In the vehicular hybrid drive system 10 of this embodiment, the input pulley 42 of the belt-and-pulley continuous variable transmission 20 is mechanically connected to the engine 12 via the input shaft 18, spring damper 16, etc., and is arranged to be rotated and stopped along with the engine 12 at all times; therefore, substantially the same function as that of a flywheel is provided by the inertia of the input pulley 42. The input pulley 42 of the belt-and-pulley continuous variable transmission 20 of this embodiment has a large diameter, and sufficiently functions as a substitute for a flywheel. Thus, there is no need to additionally provide a flywheel for reducing fluctuations in the torque and rotation (rotational speed) of the engine 12, which leads to reduction in the weight of the system and improved fuel efficiency. Also, the hybrid drive system 10 thus constructed has a simple structure, which is available at a reduced cost, and is advantageous in terms of installation space and weight.

Also, the first motor-generator MG1 is mechanically connected to the input pulley 42 via the input shaft 18 and the spring damper 16, and the input pulley 42 is rotated and stopped along with the first motor-generator MG1 at all times. Therefore, fluctuations in the torque and rotation (rotational speed) of the first motor-generator MG1 are reduced by the inertia of the input pulley 42, and the NV performance is further improved.

To cause the vehicle to run backward, the second motor-generator is controlled to operate as an electric motor, to be rotated in the reverse direction, in a condition where the start clutch 26 is released and the engine 12, first motor-generator MG1, and the belt-and-pulley continuous variable transmission 20 are disconnected from the front driving wheels 40L, 40R. Therefore, it is not necessary to provide a forward/reverse drive switching device that would be required when the vehicle runs backward using the engine 12 as a driving power source. Thus, the system has a further simplified structure, which is available at a reduced cost, and is further advantageous in terms of installation space and weight. In particular, while the forward/reverse drive switching device normally includes hydraulic clutch and brake, and a hydraulic circuit needs to be provided for controlling the clutch and brake, the elimination of the forward/reverse drive switching device makes it unnecessary to provide the hydraulic circuit and control the switching device, resulting in a significant reduction of the cost.

For backward running of the vehicle, the hybrid drive system 10 may operate in the EV running mode in which the engine 12 is stopped in a condition where the start clutch 26 is released, and the second motor-generator MG2 is controlled to be driven or rotated in the reverse direction so as to run the vehicle backward, and may also operate in the series HEV running mode in which the engine 12 is operated during running in the EV mode so as to rotate or drive the first motor-generator MG1, and the first motor-generator MG1 is controlled so as to generate electric power or energy, so that the obtained electric energy is supplied to the second motor-generator MG2. Thus, the vehicle is able to run backward with reliability even if the SOC of the battery 62 is reduced to a low level.

When the motor running unit 72 causes the vehicle to run forward in the series HEV mode, the shift control unit 80 performs the above-described synchronization control so as to control the speed ratio γ of the belt-and-pulley continuous variable transmission 20 according to the vehicle speed V so that the upstream and downstream elements of the start clutch 26 rotate in synchronism with each other. Therefore, when the motor/engine switching unit 76 switches the vehicle from motor-based running to engine-based running in response to an operation to increase the amount of depression of the accelerator pedal or an increase of the vehicle speed V, for example, the start clutch 26 can be quickly engaged without causing shock to occur, and the driving force can be readily obtained from the engine 12 due to reduction of torque used for power generation control of the first motor-generator MG1, thus assuring excellent driving-force responsivity.

Next, another embodiment of the invention will be described. In the following embodiment, the same reference numerals are assigned to portions or elements that are substantially identical with those of the above-described embodiment, and these portions or elements will not be described in detail.

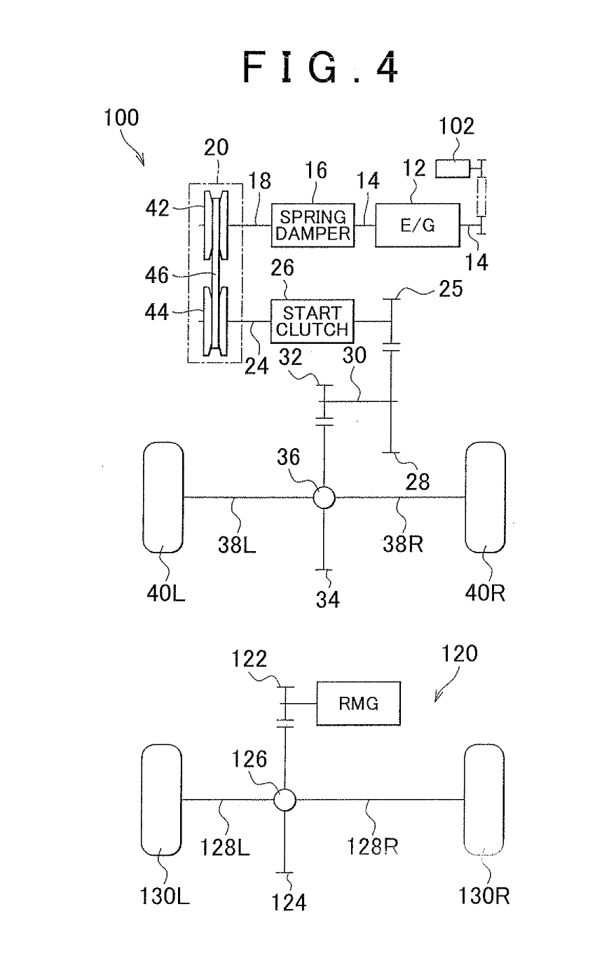

FIG. 4 is a schematic diagram of another example of vehicular hybrid drive system to which the invention is favorably applied. The vehicular hybrid drive system 100 is different from that of the above-described embodiment in that a starter motor 102 is connected via a belt, or the like, to the crankshaft 14 that protrudes backward from the engine 12, the engine 12 is cranked by the starter motor 102, the spring damper 16 is disposed between the crankshaft 14 and the input shaft 18, and that the second motor-generator MG2 is not provided. Rather, the vehicular hybrid drive system 100 includes a rear-wheel drive system 120, which includes a motor-generator RMG for rear wheels and a differential gear unit 126. The rear-wheel motor-generator RMG is operable to rotate or drive the differential gear unit 126 via a fifth gear 122 and a sixth gear 124, so that left and right rear driving wheels 130L, 130R are rotated or driven via left and right axles 128L, 128R, respectively. The starter motor 102, which may be regarded as a first rotary machine, is in the form of a motor-generator that functions as a generator as well as an electric motor. When the starter motor 102 is rotated or driven by the engine 12 and is controlled to generate electric power or energy, the electric energy is supplied to the rear-wheel motor-generator RMG so that the vehicle can run in the series HEV running mode. The rear-wheel motor-generator RMG may be regarded as a second rotary machine.

In the vehicular hybrid drive system 100, too, the input pulley 42 of the belt-and-pulley continuously variable transmission 20 is mechanically connected to the engine 12 via the input shaft 18 and the spring damper 16, and is rotated and stopped along with the engine 12 at all times. If the “MG1” is replaced by the “starter motor 102” and the “MG2” is replaced by the “rear-wheel motor-generator RMG” in FIGS. 3A and 3B, the vehicle is able to run in all of the various running modes as shown in FIGS. 3A and 3B, and the vehicular hybrid drive system 100 of this embodiment provides substantially the same effects as those provided by the, vehicular hybrid drive system 10 of the above-described embodiment.

The summary of each embodiment of the invention will be provided below.

The invention relates to a vehicular hybrid drive system. The hybrid drive system includes: (a) an engine, (b) a first rotary machine that is mechanically connected to the engine and is used at least as a generator, (e) a belt-and-pulley continuously variable transmission to which output of the engine and the first rotary machine is transmitted via an input shaft, (d) a clutch device that permits and interrupts power transmission between the belt-and-pulley continuously variable transmission and driving wheels, and (e) a second rotary machine that is used at least as an electric motor, and is arranged to cause a vehicle to run even when the engine is stopped. In the hybrid drive system, an input pulley of the belt-and-pulley continuously variable transmission is disposed coaxially with the engine, and is mechanically connected to the engine via the input shaft, such that the input pulley is rotated and stopped along with the engine at all times.

In the vehicular hybrid drive system as described above, power transmission between the belt-and-pulley continuously variable transmission and the driving wheels may be interrupted by the clutch device during backward running, and the vehicle may run backward using the second rotary machine as the electric motor.

According to the vehicular hybrid drive system as described above, the vehicle runs backward, using the second rotary machine as the electric motor, in a condition where the clutch device is released, and the engine, first rotary machine and the belt-and-pulley continuously variable transmission are disconnected from the driving wheels; therefore, there is no need to provide a forward/reverse drive switching device that would be required if the vehicle runs backward using the engine as the driving power source. Thus, the system is simply and inexpensively constructed, and is also advantageous in terms of installation space and weight. In particular, while the forward/reverse drive switching device normally includes hydraulic clutch and brake, and a hydraulic circuit needs to be provided for controlling the clutch and brake, the elimination of the forward/reverse drive switching device makes it unnecessary to provide the hydraulic circuit and control the switching device, resulting in a significant reduction of the cost.

In the vehicular hybrid drive system as described above, when the vehicle runs forward in a series HEV mode in which power transmission between the belt-and-pulley continuously variable transmission and the driving wheels is interrupted by the clutch device, and the second rotary machine is used as the electric motor for forward running of the vehicle, while electric energy obtained by using the first rotary machine as the generator is supplied to the second rotary machine, the speed ratio of the belt-and-pulley continuously variable transmission may be controlled according to the vehicle speed so that upstream and downstream elements of the clutch device rotate in synchronism with each other.

According to the vehicular hybrid drive system as described above, the speed ratio of the belt-and-pulley continuously variable transmission is controlled according to the vehicle speed, so that upstream and downstream elements of the clutch device rotate in synchronism with each other during forward running of the vehicle in the series HEV mode. Therefore, upon switching from the series HEV running to engine-based running using the engine as the driving power source, in response to an operation on the accelerator pedal, for example, the clutch device can be quickly engaged without causing shock to occur, and the driving force can be readily obtained from the engine, thus assuring excellent driving-force responsivity.

The engine is for example, an internal combustion engine that generates power utilizing combustion of fuel, and the rotary machine is an electric motor that generates power with electric energy, or a generator that is rotated or driven so as to generate electric power, or a motor-generator that can selectively use the functions of both the electric motor and the generator. The first rotary machine, which is used at least as the generator, may be in the form of a generator or a motor-generator. Where the first rotary machine is used as a starter motor for starting the engine, or used as a driving power source for running the vehicle, a motor-generator is used as the first rotary machine. The second rotary machine, which is used at least as the electric motor, may be in the form of an electric motor or a motor-generator. Where the second rotary machine is used as a generator during deceleration of the vehicle, for example, so as to charge the battery, a motor-generator is used as the second rotary machine.

While the engine is arranged to rotate or drive one pair of front wheels and rear wheels, for example, the engine may be arranged to rotate or drive both pairs of front wheels and rear wheels, via a front-/rear-wheel distribution device, such as a planetary gear set, provided on one side of the clutch device closer to the wheels. While the first rotary machine may be disposed coaxially with the engine and is coupled integrally to the crankshaft, or the like, the first rotary machine may take various forms, for example, it may be connected to the crankshaft of the engine, or the like, via a speed-change gear for reducing or increasing the rotational speed, pulley, sprocket, or the like. The first rotary machine may be connected at a position between the engine and the belt-and-pulley continuously variable transmission, or may be disposed on one side of the engine opposite to the belt-and-pulley continuously variable transmission. The second rotary machine is connected to a power transmission path between the clutch device and the driving wheels, for example, and is arranged to rotate or drive the same wheels as those rotated or driven by the engine. However, in the case where the engine drives one pair of front and rear wheels, for example, the second rotary machine may be placed so as to rotate or drive the other pair of front and rear wheels.

While a hydraulic friction clutch or an electromagnetic friction clutch is preferably used as the clutch device, the clutch device may be of other types provided that it can permit and interrupt power transmission. For example, a forward/reverse drive switching device of planetary gear type having a forward clutch and a reverse brake, for example, may be used as the clutch device. In this case, power transmission is interrupted when the forward clutch and the reverse brake are both released.

It is desirable to provide a damper device, such as a spring damper, for absorbing fluctuations in the rotation (rotational speed) of the engine, between the engine and the belt-and-pulley continuously variable transmission. While the input pulley of the belt-and-pulley continuously variable transmission is rotated and stopped along with the engine at all times, the damper device permits the input pulley to rotate slightly relative to the engine. Also, while a flywheel for reducing fluctuations in the torque and rotational speed of the engine is not necessarily required, a flywheel may be additionally provided as needed in the case where sufficient inertia cannot be achieved by the input pulley alone, for example.

In order to mechanically connect the input pulley of the belt-and-pulley continuously variable transmission and the engine, two or more members, such as the input shaft and the damper device, the damper device and the rotary shaft of the first rotary machine, and the rotary shaft of the first rotary machine and the crankshaft of the engine, are coupled to each other via splines, or the like, such that they cannot rotate relative to each other. However, one or more combinations of the above-indicated members may be secured to each other by a fastening member(s), such as a bolt(s), or may be formed as an integral assembly or unit if possible.

When the vehicle runs backward, the second rotary machine is used as an electric motor, in a condition where the clutch device is disengaged, and the engine, first rotary machine, and the belt-and-pulley continuously variable transmission are disconnected from the driving wheels. In this case, if the SOC (state of charge) of the battery is equal to or less than a predetermined value, the engine may be cranked and started by the first rotary machine, and then the vehicle may run backward in the series

HEV mode in which the first rotary machine is rotated or driven by the engine so as to generate electric power or energy (i.e., the first rotary machine operates as a generator), and the thus obtained electric energy is supplied to the second rotary machine. The predetermined value of the SOC at which the backward running in the series HEV mode is started is within a SOC range in which the engine can be cranked and started by the first rotary machine. The vehicle may run backward in the series HEV mode at all times, irrespective of the SOC.

While the invention has been described with reference to example embodiments thereof, it is to be understood that the invention is not limited to the described embodiments or constructions. The invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A vehicular hybrid drive system, comprising:
an engine;
a first rotary machine that is mechanically connected to the engine and is used at least as a generator;
a belt-and-pulley continuously variable transmission to which output of the engine and the first rotary machine is transmitted via an input shaft;
a clutch device that permits and interrupts power transmission between the belt-and-pulley continuously variable transmission and driving wheels; and
a second rotary machine that is used at least as an electric motor, and is arranged to cause a vehicle to run even when the engine is stopped, wherein an input pulley of the belt-and-pulley continuously variable transmission is disposed coaxially with the engine, and is mechanically connected to the engine via the input shaft, such that the input pulley is rotated and stopped along with the engine at all times.

2. The vehicular hybrid drive system according to claim 1, wherein power transmission between the belt-and-pulley continuously variable transmission and the driving wheels is interrupted by the clutch device during backward running, and the vehicle runs backward using the second rotary machine as the electric motor.

3. The vehicular hybrid drive system according to claim 1, wherein when the vehicle runs forward in a series hybrid electric vehicle mode in which power transmission between the belt-and-pulley continuously variable transmission and the driving wheels is interrupted by the clutch device, and the second rotary machine is used as the electric motor for forward running of the vehicle, while electric energy obtained by using the first rotary machine as the generator is supplied to the second rotary machine, the speed ratio of the belt-and-pulley continuously variable transmission is controlled according to the vehicle speed so that upstream and downstream elements of the clutch device rotate in synchronism with each other.

4. The vehicular hybrid drive system according to claim 1, further comprising:
an output shaft that transmits power between the belt-and-pulley continuously variable transmission and the clutch device; and
a gear that transmits power between the driving wheels and the clutch device, wherein
when the vehicle runs forward in a series hybrid electric vehicle mode in which power transmission between the belt-and-pulley continuously variable transmission and the driving wheels is interrupted by the clutch device, and the second rotary machine is used as the electric motor, while the first rotary machine is driven by the engine so that electric energy obtained by using the first rotary machine as the generator is supplied to the second rotary machine, the speed ratio of the belt-and-pulley continuously variable transmission is controlled according to the vehicle speed, so that the output shaft and the gear rotate in synchronism with each other.

5. The vehicular hybrid drive system according to claim 1, wherein an axis of rotation of the engine and an axis of rotation of the first rotary machine are provided on the same axis.

6. The vehicular hybrid drive system according to claim 1, wherein an axis of rotation of the engine and an axis of rotation of the second rotary machine are offset from each other.

7. The vehicular hybrid drive system according to claim 1, wherein an shaft of rotation of the engine and an shaft of rotation of the second rotary machine are separate from each other.
